(19) United States
(12) Patent Application Publication
(10) Pub. No.: US 2020/0195333 A1
(43) Pub. Date: Jun. 18, 2020

(54) BEAM SELECTION METHOD, MOBILE STATION, AND BASE STATION

(71) Applicant: NTT DOCOMO, INC., Tokyo (JP)

(72) Inventors: Huiling LI, Beijing (CN); Chongning NA, Beijing (CN); Huiling JIANG, Beijing (CN); Yuichi KAKISHIMA, Tokyo (JP); Satoshi NAGATA, Tokyo (JP)

(73) Assignee: NTT DOCOMO, INC., Tokyo (JP)

(21) Appl. No.: 16/473,997

(22) PCT Filed: Jan. 4, 2018
(86) PCT No.: PCT/CN2018/071318

§ 371 Date: Jun. 26, 2019

(30) Foreign Application Priority Data
Jan. 5, 2017 (CN) 201710007922.9

(51) Int. Cl. H04B 7/08; H04B 7/06; H04B 7/0408

(52) U.S. Cl. CPC H04B 7/088; H04B 7/0695; H04B 7/0408; H04B 7/0626

(57) ABSTRACT

Embodiments of the present application provide a beam selection method, a mobile station, and a base station. The beam selection method according to the embodiments of the application including: selecting one leading beam from a plurality of beams; selecting one combined beam from the plurality of beams according to the selected leading beam, where the leading beam and the combined beam are both located in one beam group, and beams in the beam group are orthogonal and adjacent to each other; determining a corresponding reference beam according to the beam group, wherein the reference beam is used to indicate a range of the beam group and is different from the leading beam.

### TECHNICAL FIELD

The present application relates to a field of communication technologies, and in particular to a beam selection method, a mobile station, and a base station.

### BACKGROUND

Conventionally, a base station communicates with a mobile station by using a one-dimensional antenna. In recent years, in order to further improve a signal transmission quality between the base station and the mobile station and to increase throughput of a wireless communication system, a three-dimensional beamforming technique has been proposed. In the three-dimensional beamforming technique, the base station communicates with the mobile station by using a two-dimensional antenna array. Compared with the one-dimensional antenna, in addition to deploying antennas in a horizontal dimension and performing horizontal beam steering, the two-dimensional antenna array also deploys antennas and carries out beam steering in a vertical dimension (height direction), so as to achieve the three-dimensional beamforming. Through the three-dimensional beamforming, a higher beamforming gain may be obtained, and a good signal transmission quality may be obtained by the mobile stations at different positions (especially positions at different heights).

On the other hand, channel estimation is required before the base station transmits downlink data to the mobile station. In particular, the base station transmits a channel state information reference signal (CSI-RS) to the mobile station, and the mobile station carries out channel estimation through the CSI-RS, and feeds back information, such as a rank indicator (RI), a precoding matrix index (PMI), and a channel quality indicator (CQI) or the like. Then the base station precodes the data based on the information fed back by the mobile station. In the prior art, for a design of a linear combination codebook for CSI reporting, the mobile station usually selects one beam group from a plurality of beams, and determines one or two beams therein from this beam group and feeds them back to the base station. However, the current beam selection method usually leads limitation of the beam selection, which may reduce a channel quality during information transmission or reduce coverage of the information transmission.

### SUMMARY OF THE INVENTION

According to one aspect of the present application, a beam selection method is provided, the method being performed by a mobile station, comprising: selecting one leading beam from a plurality of beams; selecting one combined beam from the plurality of beams according to the selected leading beam, where the leading beam and the combined beam are both located in one beam group, and beams in the beam group are orthogonal and adjacent to each other; determining a corresponding reference beam according to the beam group, wherein the reference beam is used to indicate a range of the beam group and is different from the leading beam.

According to another aspect of the present application, a beam selection method is provided, the method being performed by the mobile station, comprising: selecting one leading beam from a plurality of beams; selecting one combined beam from the plurality of beams according to the selected leading beam, where the leading beam and the combined beam are both located in one beam group, and beams in the beam group are orthogonal and not adjacent to each other.

According to another aspect of the present application, a beam selection method is provided, the method being performed by a base station, comprising: selecting one leading beam from a plurality of beams; selecting one combined beam from the plurality of beams according to the selected leading beam, where the leading beam and the combined beam are both located in one beam group, and beams in the beam group are orthogonal and adjacent to each other; determining a corresponding reference beam according to the beam group, wherein the reference beam is used to indicate a range of the beam group and is different from the leading beam.

According to another aspect of the present application, a beam selection method is provided, the method being performed by a base station, comprising: selecting one leading beam from a plurality of beams; selecting one combined beam from the plurality of beams according to the selected leading beam, where the leading beam and the combined beam are both located in one beam group, and beams in the beam group are orthogonal and not adjacent to each other; transmitting information to a mobile station with a combination of the selected leading beam and the combined beam.

According to another aspect of the present application, a mobile station is provided, comprising: a first leading beam selecting unit configured to select one leading beam from a plurality of beams; a first combined beam selecting unit configured to select one combined beam from the plurality of beams according to the selected leading beam, where the leading beam and the combined beam are both located in one beam group, and beams in the beam group are orthogonal and adjacent to each other; a first reference beam determining unit configured to determine a corresponding reference beam according to the beam group, wherein the reference beam is used to indicate a range of the beam group and is different from the leading beam.

According to another aspect of the present application, a base station is provided, comprising: a second leading beam selecting unit configured to select one leading beam from a plurality of beams; a second combined beam selecting unit configured to select one combined beam from the plurality of beams according to the selected leading beam, where the leading beam and the combined beam are both located in one beam group, and beams in the beam group are orthogonal and adjacent to each other; a second reference beam determining unit configured to determine a corresponding reference beam according to the beam group, wherein the reference beam is used to indicate a range of the beam group and is different from the leading beam; and a first transmitting unit configured to transmit information to a mobile station with a combination of the selected leading beam and the combined beam.

According to another aspect of the present application, a mobile station is provided, comprising: a third leading beam selecting unit configured to select one leading beam from a plurality of beams; a third combined beam selecting unit configured to select one combined beam from the plurality of beams according to the selected leading beam, where the leading beam and the combined beam are both located in one beam group, and beams in the beam group are orthogonal and adjacent to each other.

According to another aspect of the present application, a base station is provided, comprising: a fourth leading beam selecting unit configured to select one leading beam from a plurality of beams; and a fourth combined beam selecting unit configured to select one combined beam from the plurality of beams according to the selected leading beam, where the leading beam and the combined beam are both located in one beam group, and beams in the beam group are orthogonal and adjacent to each other; a second transmitting unit configured to transmit information to a mobile station with a combination of the selected leading beam and the combined beam.

With the beam selection method, the mobile station and the base station according to the above aspect of the present application, a beam selection range may be expanded, thereby optimizing a configuration of a channel transmission resource, increasing a coverage of a channel transmission, and improving an information transmission quality.

### BRIEF DESCRIPTION OF THE DRAWINGS

The above and other objects, features and advantages of the present disclosure will become more apparent by describing embodiments of the present disclosure in more details with reference to the drawings.

FIG. 1 shows a schematic diagram of a design scheme of a codebook, where FIG. 1(a) and FIG. 1(b) respectively show two beam selection schemes;

FIG. 2 shows a schematic diagram of a codebook determined by a base station based on a DFT matrix;

FIG. 3 shows a schematic diagram of a combination of orthogonal beam of a leading beam of the codebook in FIG. 2;

FIG. 4 shows a schematic diagram of a selection scheme of a 32-port combined beam;

FIG. 5 shows a schematic diagram of a coverage of beam group in a 8-port and a 16-port;

FIG. 6 shows a flowchart of a beam selection method of a first embodiment of the present application;

FIG. 7 shows an exemplary diagram of beam selection in a case of a multi-port antenna of a first embodiment of the present application;

FIG. 8 shows a block diagram of a structure of a mobile station of a first embodiment of the present application;

FIG. 9 shows a flowchart of a beam selection method of a second embodiment of the present application;

FIG. 10 shows a block diagram of a structure of a base station of a second embodiment of the present application;

FIG. 11 shows a flowchart of a beam selection method of a third embodiment of the present application;

FIG. 12 shows a schematic diagram of search range of a combined beam of a third embodiment of the present application, where FIG. 12(a) represents a search range laterally spaced from a leading beam, FIG. 12(b) represents a search range longitudinally spaced from the leading beam, and FIGS. 12 (c) and (d) represent a search range diagonally connected to and cross spaced from the leading beam;

FIG. 13 shows an exemplary diagram of a beam selection for diagonally connected and cross spaced in a case of a multi-port antenna in the beam selection method of the third embodiment of the present application;

FIG. 14 shows an exemplary diagram of a beam selection for laterally spaced or longitudinally spaced in a case of a multi-port antenna in the beam selection method of the third embodiment of the present application;

FIG. 15 shows a block diagram of a structure of a mobile station of a third embodiment of the present application;

FIG. 16 shows a flowchart of a beam selection method of a fourth embodiment of the present application;

FIG. 17 shows a block diagram of a structure of a base station of a fourth embodiment of the present application;

FIG. 18 shows a schematic diagram of a beam group selection of one embodiment of the present application;

FIG. 19 shows a schematic diagram of a beam group selection of another embodiment of the present application.

### DESCRIPTION OF THE EMBODIMENTS

A beam selection method, a mobile station, and a base station according to embodiments of the present application will be described below with reference to the drawings. In the drawings, same reference numerals are used to refer to same elements. It should be understood that the embodiments described herein are only illustrative and are not to be construed as limiting a scope of the application.

A codebook design of Release 13 is two-order: W=W1W2, where W1 selects one group of beams, and W2 selects one beam from the one group of beams, that is, the codebook of Release 13 is a beam selection. In a discussion of Release 14 advanced CSI, a PMI enhancement is one of topics discussed. In the PMI enhancement scheme, a linear combination of beams is one of alternative schemes. Compared to the beam selection of Release 13, the beam combination quantizes and combines a plurality of beams. The linear combination of beams may improve accuracy of channel quantization and improve accuracy of feedback, thereby improving system performance. In a feedback of Release 14 advanced CSI, the codebook is combined by two orthogonal beams, which are located in one beam group. A design of existing scheme makes some restrictions to a composition of the beam group and the selection of the combined beam, so as to reduce overhead of the feedback. For example, a number of beams in the orthogonal beam group is no more than eight, and a shape of the beam group is regular: 4*2 or 8*1 or the like.

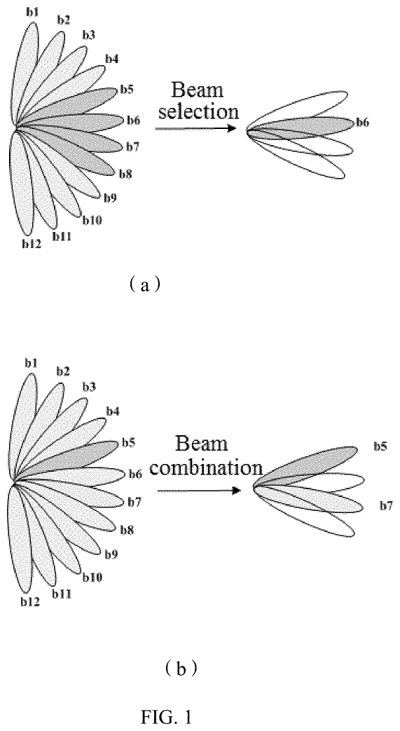

FIG. 1 shows a design scheme of the codebook, where FIG. 1(a) represents a beam selection scheme that one group of beams is first selected in the plurality of beams, and then one beam b6 is selected from the group of beams, and FIG. 1 (b) represents a beam selection scheme where one leading beam b5 is selected and combined with one combined beam b7, so as to form a beam combination.

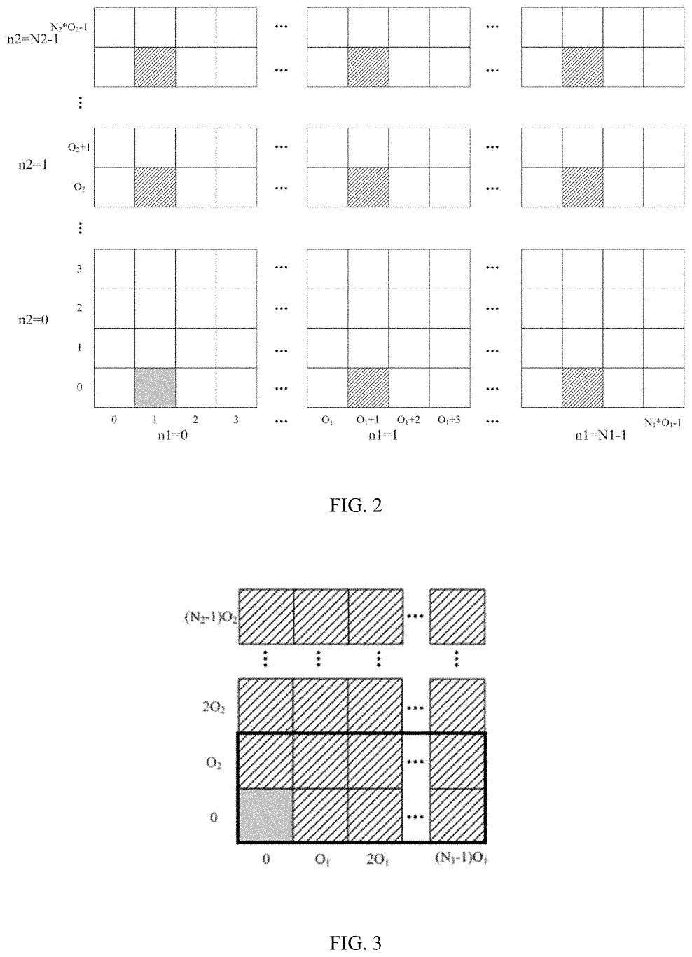

The beam selection schemes of FIG. 1(a) and FIG. 1(b) may be both applied in a wireless communication system, which can include at least one base station and at least one mobile station. The base station may be connected to an upper layer apparatus and then to a core network, where the base station may be equipped with a two-dimensional antenna array and can communicate with the mobile station through this antenna array. First, the base station can design the codebook based on the DFT matrix. FIG. 2 shows a schematic diagram of the codebook determined by the base station based on the DFT matrix. Parameters N₁ and N₂ in FIG. 2 are numbers of antenna ports of a first dimension and a second dimension, respectively, and O1 and O2 are oversampling ratios of the first dimension and the second dimension, respectively. The base station can then share the determined codebook to the mobile station, such that the base station and the mobile station share a known set of codebooks and perform subsequent information transmission based on the set of codebooks. After the mobile station selects one or several beams from the plurality of beams and feeds them back to the base station, the base station may perform the transmitting of the downlink data based on this beam feedback.

In particular, in the scheme shown in FIG. 1(b), combined with that shown in FIG. 2, the mobile station may first select one leading beam (a gray beam in a lower left corner of FIG. 2) according to the channel state and based on the shared known codebook. Subsequently, the mobile station may obtain all orthogonal beams (beams covered by shaded portions in FIG. 2) orthogonal thereto according to the determined leading beam, and simplify them to an orthogonal beam combination shown in FIG. 3. In the orthogonal beam combination shown in FIG. 3, one beam group which is boxed by a block is included. In the one beam group, a combined beam which can be combined with the leading beam may be selected. In the one beam group, the leading beam is located in the lower left corner of the block. It may be known that in the present scheme, indexes of the leading beam may be represented as: k₁⁽⁰⁾=i_{1,1}=0, 1, . . . N₁O₁−1, k₂⁽⁰⁾=i_{1,2}=0, 1, . . . N₂O₂−1, where k₁⁽⁰⁾ and k₂⁽⁰⁾ are mapping positions of the leading beam in the first dimension and the second dimension, respectively. Correspondingly, indexes of the combined beam that may be selected may be represented as: k₁⁽¹⁾=i_{1,1}+O₁d₁, k₂⁽¹⁾=i_{1,2}+O₂d₂, where k₁⁽¹⁾ and k₂⁽¹⁾ are mapping positions of the combined beam in the first dimension and the second dimension, respectively. Wherein, since the combined beam needs to be selected in the beam group defined by the block in the orthogonal beam combination as shown in FIG. 3, in general, the number of beams in the beam group may be defined to 8 in consideration of the limitation of feedback load of the communication system. According to range of values of N1 and N2 inferred from the different number of antenna ports, it may be defined that d₁=0, . . . , min(N₁,L₁)−1, d₂=0, . . . , min(N₂,L₂)−1, (d₁,d₂)≠(0,0), where L₁=4, L₂=2 (N₁≥N₂ and N₂≠1); L₁=2, L₂=4 (N₁<N₂ and N₂≠1); L₁=8, L₂=1 (N₂=1). That is, for example, when the number of antenna ports is 24, (N1, N2) may have a plurality of choices of (2, 6), (3, 4), (4, 3), (6, 2), (12, 1), when (N1, N2) takes the values of (4, 3) or (6, 2), the beam group L₁=4, L₂=2; when (N1, N2) takes values of (3, 4) or (2, 6), the beam group L₁=2, L₂=4; when (N1, N2) takes values of (12, 1), the beam group L₁=8, L₂=1. In these manners of the selections of the beam group, the numbers of beams included in the beam group are all eight. The number of beams referred to herein may be determined by the base station and notified to the mobile station, or may be suggested by the mobile station to the base station, or may be a number defaulted by both the base station and the mobile station based on certain principles. In addition, it is only an example that the numbers of the above-mentioned beams are 8. In practical applications, the numbers of beams that may be included in the beam group may be more or less, which is not limited herein.

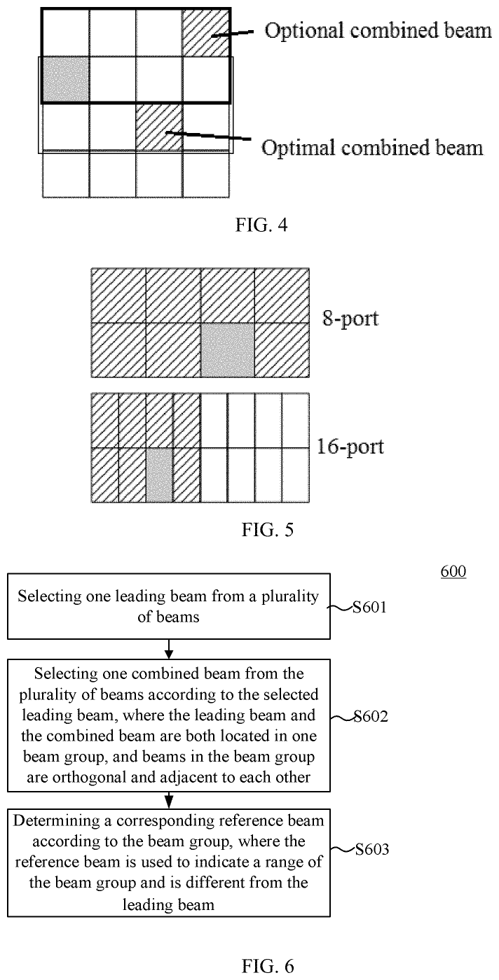

Since the leading beam, which is included in the beam group defined by the beam selection schemes described above, must be located in the lower left corner thereof, it means that its combined beam may only be selected at the position of the upper right corner of the leading beam within the range of the beam group. Therefore, when the number of antenna ports is large (for example, 20, 24, 28, 32 or the like.), it may result that some other combined beam that cannot be included in this beam group cannot be selected, while these combined beam that cannot be selected may enable better channel state after combining. This leads to the selection limitation of the combined beam and may affect the quality of information transmission in the communication system. FIG. 4 shows a schematic diagram of a selection scheme of a 32-port combined beam (with (N₁, N₂) taking values of ((4, 4)). It may be seen that in the beam group where the currently defined leading beam is located in the lower left corner of the beam group which contains 8 beams, only an optional combined beam in the upper right corner may be selected and combined with the leading beam. However, actually, an optimal combined beam, which is located in the lower right of the leading beam and not included in beam group, is the combined beam that can able to make the channel state optimal. In the current schemes, this optimal combined beam cannot be considered and selected due to the partitioning limitation of the beam group.

In addition, considering the trade-off problem of the feedback load, only a limited number of beams may be selected in the beam group, while the coverage of all the beams in the selected beam group decreases correspondingly as the number of antenna ports increases. FIG. 5 shows difference in coverage of beam group in 8-port and 16-port. It may be seen that in the case of 16-port, the coverage of the optional combined beam reduces to one half of that of the 8-port antenna, and this problem will be more serious when the number of antenna ports becomes larger.

### First Embodiment

In view of the limitation problems of the combined beam selection described above, it is considered to propose the following beam selection method. FIG. 6 shows a flowchart of a beam selection method 600 according to the embodiments of the present application, which may be performed by a mobile station.

As shown in FIG. 6, in step S601, the mobile station selects one leading beam from a plurality of beams. In this step, as mentioned above, the mobile station may select one leading beam from the plurality of beams according to conditions associated with channel quality, data throughput, or transmission power of a channel corresponding to respective beams. In particular, the mobile station may carry out channel estimation for each beam, so as to determine the channel quality of the channel corresponding to each beam, which may be represented by, for example, a channel quality indicator (CQI) or the like. In addition, for each beam, the mobile station may also determine a corresponding rank indicator (RI), a precoding matrix index (PMI) or the like.

In step S602, one combined beam is selected from the plurality of beams according to the selected leading beam, where the leading beam and the combined beam are both located in one beam group, and beams in the beam group are orthogonal and adjacent to each other. In this step, the selection for the combined beam will not be subject to the previous mentioned limitation that the combined beam must be located in the upper right of the leading beam in a limited number (for example, 8) of the beam group, but a orthogonal beam with the best channel quality after combining with the leading beam may be searched around the leading beam and selected as the combined beam. The method of determining the combined beam is similar to the method of determining the leading beam described above, i.e., the combined beam may also be selected by the conditions associated with the channel quality, the data throughput, or the transmission power after the combination of the leading beam and the combined beam.

In the embodiments of the present application, after the selection of the leading beam and the combined beam, alternatively, the beam group including a preset number (for example, 8) of beams may be determined with the leading beam and the combined beam. In practical applications, the number of beams of the beam group may be any number. Preferably, in order to save feedback overhead, the beam group may include 2ⁿ or 2ⁿ+1 beams. In addition, for different numbers of antenna port, beam group with the same number of beams may be set to make the feedback load same, thereby simplifying system setting.

In step S603, a corresponding reference beam is determined according to the beam group, where the reference beam is used to indicate a range of the beam group and is different from the leading beam.

The position of the reference beam in the beam group may be preset and may be located at any determined preset position of the beam group. Alternatively, the reference beam may be located as close as possible to the leading beam, and preferably, the reference beam may be located in the lower left corner of the beam group. The range of the beam group and the relative position of the reference beam in the beam group may be not only specified by the base station to the mobile station, but also fed back to the base station by the mobile station, or learned by the base station and the mobile station based on preset rules. In one embodiment of the application, the reference beam may be different from the leading beam.

Certainly, in another embodiment of the present application, the reference beam may also be undefined, and the mobile station may directly select the leading beam and the combined beam combined with the leading beam according to the steps S601-S602 described above to complete the beam selection method described above.

Alternatively, after the mobile station determines the range of the beam group and the position of the reference beam, the mobile station may feed back information indicating the reference beam to the base station, and indicate the position of the selected leading beam and the combined beam relative to the reference beam to the base station based on the information. In the embodiments of the present application, the mobile station may select any suitable manner as needed to feed back the information of the reference beam, for example, the mobile station may feed back an index of the reference beam, and enable the base station determine the leading beam and the combined beam by feeding back the position of the leading beam and the combined beam relative to the reference beam. The feedback manners of the mobile station may be configured by the base station. For example, the mobile station may feed back the reference beam index periodically or non-periodically. In addition, the mobile station may feed back the reference beam index at a longer time interval and/or for a wide frequency band. The mobile station may feed back the reference beam index at a same timing or frequency as the RI. In a case that the mobile station is configured to carry out an aperiodic feedback, the mobile station may feed back the index of the reference beam with at least one of RI, PMI and CQI; in a case that the mobile station is configured for periodic feedback, a feedback period of the reference beam index may be the same as or different from a feedback period of the RI, PMI and/or CQI.

In addition, when the mobile station does not need to determine the reference beam, the mobile station may directly feed back the information indicating the leading beam and the combined beam to the base station. For example, the mobile station may respectively feed back the leading beam index and the combined beam index to the base station, or may feed back the leading beam index to the base station, and then feed back the information of combined beam through a position of the combined beam relative to the leading beam. The feedback manner of the leading beam index is similar to that of the reference beam index described above, and is not described herein.

Where the difference between the beam selection method in the embodiments of the present application and the current standardization working assumption is: when the leading beam index is represented as: k₁⁽⁰⁾=i_{1,1}=0, 1, . . . N₁O₁−1, k₂(0)=i_{1,2}=0, 1, . . . N₂O₂−1, the combined beam index that may be selected may be modified as: k₁⁽¹⁾=i_{1,1}+O₁d₁, k₂⁽¹⁾=i_{1,2}+O₂d₂. A range of values of N1 and N2 inferred from the different number of antenna ports may also define d₁=0, . . . , min(N₁,L₁)−1, d₂=0, . . . , min(N₂,L₂)−1, (d₁,d₂) (0,0). The values of L₁ and L₂ are as described above.

After receiving the beam index fed back by the mobile station, the base station may acquire a corresponding CSI-RS or CSI process according to the determined leading beam and combined beam, and then determine a precoding vector suitable for data transmitted to the mobile station. The base station may then precode the data that will be transmitted to the mobile station using the precoding vector and transmit the precoded data to the mobile station.

In the beam selection method according to the embodiments of the present application, the beam selection range may be expanded, thereby optimizing a configuration of a channel transmission resource, increasing coverage of a channel transmission, and improving an information transmission quality.

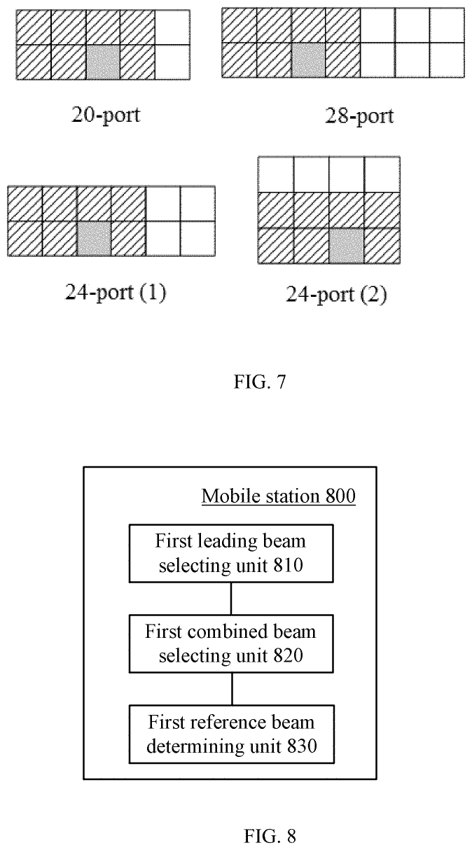

FIG. 7 shows an exemplary diagram of beam selection in a case of a multi-port antenna according to the beam selection method of the embodiments of the present application, which is a 20-port ((N1, N2) taking values of ((5, 2)), a 28-port ((N1, N2) taking values of ((7, 2)), a 24-port (1) ((N1, N2) taking values of ((6, 2)), a 28-port (2) ((N1, N2) taking values of ((3, 4)), respectively. It may be seen that in the above example, the numbers of beams of the beam group are all eight, but in other embodiments of the present application, the number of beams of the beam group is not necessarily limited to eight.

Next, the mobile station according to the first embodiment of the present application will be described with reference to FIG. 8. The UE may perform the beam selection method described above. Since the operation of the UE is substantially the same as the respective steps of the beam selection method described above, only a brief description thereof will be made herein, and a repeated description of the same content will be omitted.

As shown in FIG. 8, a UE 800 includes a first leading beam selecting unit 810, a first combined beam selecting unit 820 and a first reference beam determining unit 830. It is to be appreciated that FIG. 8 only shows means related to the embodiments of the present disclosure, while other means are omitted, but this is merely illustrative, and the UE 800 may include other means as needed.

The first leading beam selecting unit 810 selects one leading beam from the plurality of beams. As mentioned earlier, the first leading beam selecting unit 810 may select one leading beam from the plurality of beams according to the conditions associated with the channel quality, the data throughput, or the transmission power of the channel corresponding to respective beams. In particular, the first leading beam selecting unit 810 may carry out channel estimation for each beam, so as to determine the channel quality of the channel corresponding to each beam, which may be represented by, for example, the channel quality indicator (CQI) or the like.

The first combined beam selecting unit 820 may select one combined beam from the plurality of beams according to the selected leading beam, where the leading beam and the combined beam are both located in one beam group, and the beams in the beam group are orthogonal and adjacent to each other. The selection for the combined beam by the first combined beam selecting unit 820 will not be subject to the previous mentioned limitation that the combined beam must be located in the upper right of the leading beam in a limited number (for example, 8) of the beam group, but the orthogonal beam with the best channel quality after combining with the leading beam may be searched around the leading beam and selected as the combined beam. The method of determining the combined beam is similar to the method of determining the leading beam described above, i.e., the combined beam may also be selected by the conditions associated with the channel quality, the data throughput, or the transmission power after the combination of the leading beam and the combined beam.

The first reference beam determining unit 830 may determine the corresponding reference beam according to the beam group, where the reference beam is used to indicate the range of the beam group and is different from the leading beam.

In the embodiments of the present application, after the selection of the leading beam and the combined beam, alternatively, the first reference beam determining unit 830 may determine the beam group including the preset number (for example, 8) of beams with the leading beam and the combined beam, and determine its reference beam based on this beam group. The position of the reference beam in the beam group may be preset and may be located at any position of the beam group. Alternatively, the reference beam may be located as close as possible to the leading beam, and preferably, the reference beam may be located in the lower left corner of the beam group. The range of the beam group and the relative position of the reference beam in the beam group may be not only specified by the base station to the mobile station, but also fed back to the base station by the mobile station, or learned by the base station and the mobile station based on preset rules. In one embodiment of the application, the reference beam may be different from the leading beam.

Certainly, in another embodiment of the present application, the reference beam may also be undefined, and the first leading beam selecting unit 810 and the first combined beam selecting unit 820 may directly select the leading beam and the combined beam combined with the leading beam.

In addition, alternatively, after the first reference beam determining unit 830 determines the range of the beam group and the position of the reference beam, the first reference beam determining unit 830 may feed back the information indicating the reference beam to the base station, and indicate the position of the selected leading beam and the combined beam relative to the reference beam to the base station based on the information. In the embodiments of the present application, any suitable manner may be selected as needed to feed back the information of the reference beam, for example, the index of the reference beam may be fed back, and the base station may be enabled to determine the leading beam and the combined beam by feeding back the position of the leading beam and the combined beam relative to the reference beam.

In addition, when it is not necessary to determine the reference beam, the mobile station may directly feed back the information indicating the leading beam and the combined beam to the base station. For example, the mobile station may respectively feed back the leading beam index and the combined beam index to the base station, or may feed back the leading beam index to the base station, and then feed back the information of combined beam through the position of the combined beam relative to the leading beam. The feedback manner of the leading beam index is similar to that of the reference beam index described above, and is not described herein.

After receiving the beam index fed back by the mobile station, the base station may acquire the corresponding CSI-RS or CSI process according to the determined leading beam and combined beam, and then determine the precoding vector suitable for the data transmitted to the mobile station. The base station may then precode the data that will be transmitted to the mobile station using the precoding vector and transmit the precoded data to the mobile station.

The mobile station according to the embodiments of the present application can expand the beam selection range, thereby optimizing the configuration of the channel transmission resource, increasing the coverage of the channel transmission, and improving the information transmission quality.

### Second Embodiment

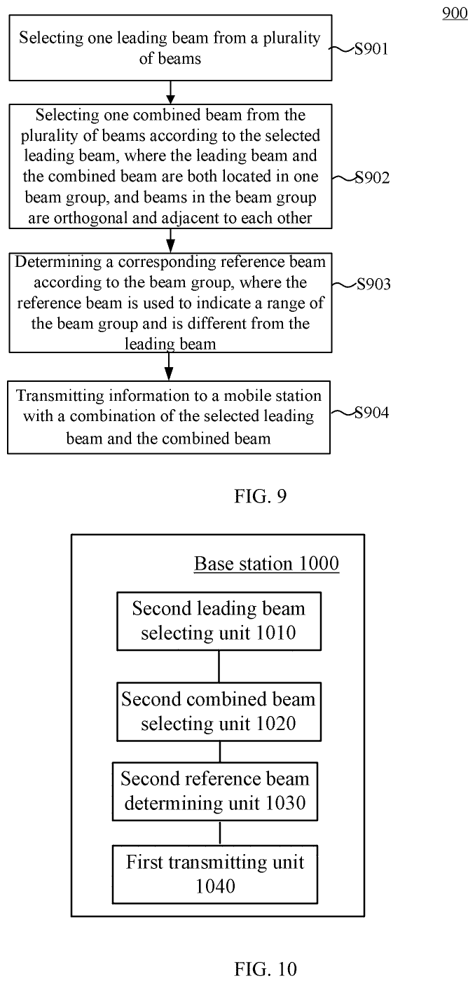

FIG. 9 shows a flowchart of a beam selection method 900 according to the embodiments of the present application, which may be performed by a base station. The beam selection method 900 performed by the base station shown in FIG. 9 is similar to the beam selection method 600 performed by the mobile station shown in FIG. 6, and same or similar descriptions are not described herein again.

As shown in FIG. 9, in step S901, the base station selects one leading beam from a plurality of beams. In this step, as mentioned above, the base station may select one leading beam from the plurality of beams according to conditions associated with channel quality, data throughput, or transmission power of a channel corresponding to respective beams fed back by the mobile station. In particular, the base station may acquire a channel estimation carried out by the mobile station for each beam, so as to determining the channel quality of the channel corresponding to each beam, which may be represented by, for example, a channel quality indicator (CQI) or the like.

In step S902, one combined beam is selected from the plurality of beams according to the selected leading beam, where the leading beam and the combined beam are both located in one beam group, and beams in the beam group are orthogonal and adjacent to each other. In this step, the selection for the combined beam by the base station will not be subject to the previous mentioned limitation that the combined beam must be located in the upper right of the leading beam in a limited number (for example, 8) of the beam group, but a orthogonal beam with the best channel quality after combining with the leading beam may be searched around the leading beam and selected as the combined beam. The method of determining the combined beam is similar to the method of determining the leading beam described above, i.e., the combined beam may also be selected by the base station by the conditions associated with the channel quality, the data throughput, or the transmission power after the combination of the leading beam and the combined beam.

In step S903, a corresponding reference beam is determined according to the beam group, where the reference beam is used to indicate a range of the beam group and is different from the leading beam.

In the embodiments of the present application, after the selection of the leading beam and the combined beam, alternatively, the base station may determine the beam group including a preset number (for example, 8) of beams with the leading beam and the combined beam, and determine its reference beam based on this beam group. The position of the reference beam in the beam group may be preset and may be located at any position of the beam group. Alternatively, the reference beam may be located as close as possible to the leading beam, and preferably, the reference beam may be located in the lower left corner of the beam group. The range of the beam group and the relative position of the reference beam in the beam group may be not only specified by the base station to the mobile station, but also fed back to the base station by the mobile station, or learned by the base station and the mobile station based on preset rules. In one embodiment of the application, the reference beam may be different from the leading beam.

Certainly, in another embodiment of the present application, the reference beam may also be undefined, and the base station may directly select the leading beam and the combined beam combined with the leading beam according to the steps S901-S902 described above.

In step S904, the base station may transmit information to the mobile station with a combination of the selected leading beam and the combined beam, where the base station may acquire a corresponding CSI-RS or CSI process according to the determined leading beam and the combined beam, and then determine a precoding vector suitable for data transmitted to the mobile station. The base station may then precode the data that will be transmitted to the mobile station using the precoding vector and transmit the precoded data to the mobile station.

In the beam selection method according to the embodiments of the present application, the beam selection range may be expanded, thereby optimizing a configuration of a channel transmission resource, increasing coverage of a channel transmission, and improving an information transmission quality.

Next, the base station according to the first embodiment of the present application will be described with reference to FIG. 10. The base station may perform the beam selection method described above. Since the operation of the base station is substantially the same as the respective steps of the beam selection method described above, only a brief description thereof will be made herein, and a repeated description of the same content will be omitted.

As shown in FIG. 10, a base station 1000 includes a second leading beam selecting unit 1010, a second combined beam selecting unit 1020, a second reference beam determining unit 1030, and a first transmitting unit 1040. It is to be appreciated that FIG. 10 only shows means related to the embodiments of the present application, while other means are omitted. But this is merely illustrative, and the base station 1000 may include other means as needed.

The second leading beam selecting unit 1010 selects one leading beam from the plurality of beams. As mentioned above, the second leading beam selecting unit 1010 may select one leading beam from the plurality of beams according to the conditions associated with the channel quality, the data throughput, or the transmission power of the channel corresponding to respective beams fed back by the mobile station. In particular, the second leading beam selecting unit 1010 may acquire the channel estimation carried out by the mobile station for each beam, so as to determining the channel quality of the channel corresponding to each beam, which may be represented by, for example, a channel quality indicator (CQI) or the like.

The second combined beam selecting unit 1020 may select one combined beam from the plurality of beams according to the selected leading beam, where the leading beam and the combined beam are both located in one beam group, and beams in the beam group are orthogonal and adjacent to each other. The selection for the combined beam by the second combined beam selecting unit 1020 will not be subject to the previous mentioned limitation that the combined beam must be located in the upper right of the leading beam in a limited number (for example, 8) of the beam group, but a orthogonal beam with the best channel quality after combining with the leading beam may be searched around the leading beam and selected as the combined beam. The method of determining the combined beam is similar to the method of determining the leading beam described above, i.e., the combined beam may also be selected by the base station by the conditions associated with the channel quality, the data throughput, or the transmission power after the combination of the leading beam and the combined beam.

The second reference beam determining unit 1030 may determine the corresponding reference beam according to the beam group, where the reference beam is used to indicate the range of the beam group and is different from the leading beam.

In the embodiments of the present application, after the selection of the leading beam and the combined beam, alternatively, the second reference beam determining unit 1030 may determine the beam group including a preset number (for example, 8) of beams with the leading beam and the combined beam, and determine its reference beam based on this beam group. The position of the reference beam in the beam group may be preset and may be located at any position of the beam group. Alternatively, the reference beam may be located as close as possible to the leading beam, and preferably, the reference beam may be located in the lower left corner of the beam group. The range of the beam group and the relative position of the reference beam in the beam group may be not only specified by the base station to the mobile station, but also fed back to the base station by the mobile station, or learned by the base station and the mobile station based on preset rules. In one embodiment of the application, the reference beam may be different from the leading beam.

Certainly, in another embodiment of the present application, the reference beam may also be undefined, and the base station may directly select the leading beam and the combined beam combined with the leading beam.

The first transmitting unit 1040 may transmit information to the mobile station with the combination of the selected leading beam and the combined beam, where the first transmitting unit 1040 may acquire the corresponding CSI-RS or CSI process according to the determined leading beam and the combined beam, and then determine the precoding vector suitable for data transmitted to the mobile station. The first transmitting unit 1040 may then precode the data that will be transmitted to the mobile station using the precoding vector and transmit the precoded data to the mobile station.

The base station according to the embodiments of the present application can expand the beam selection range, thereby optimizing the configuration of the channel transmission resource, increasing the coverage of the channel transmission, and improving the information transmission quality.

### Third Embodiment

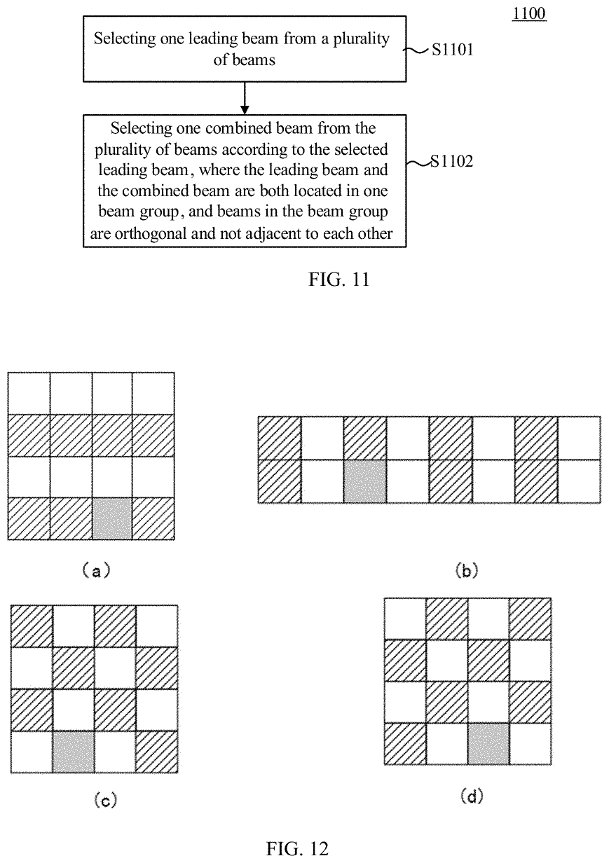

In view of the limitation problems of the above combined beam selection described above, especially problem of narrow coverage in a case of a multi-port antenna, it is considered to propose the following beam selection method. FIG. 11 shows a flowchart of a beam selection method 1100, which may be performed by a mobile station, according to the embodiments of the present application.

As shown in FIG. 11, in step S1101, the mobile station selects one leading beam from among a plurality of beams. In this step, as mentioned above, the mobile station may select one leading beam from the plurality of beams according to conditions associated with channel quality, data throughput, or transmission power of a channel corresponding to respective beams. In particular, the mobile station may carry out channel estimation for each beam, so as to determine the channel quality of the channel corresponding to each beam, which may be represented by, for example, a channel quality indicator (CQI) or the like. In addition, for each beam, the mobile station may also determine a corresponding rank indicator (RI), a precoding matrix index (PMI) or the like.

In step S1102, one combined beam is selected from the plurality of beams according to the selected leading beam, where the leading beam and the combined beam are both located in one beam group, and beams in the beam group are orthogonal and not adjacent to each other. In this step, the selection for the combined beam will be neither subject to limitation that adjacent to the leading beam, nor subject to the previous mentioned limitation that the combined beam must be located in the upper right of the leading beam in a limited number (for example, 8) of the beam group, but a orthogonal beam with the best channel quality after combining with the leading beam may be searched around the leading beam and selected as the combined beam. There are many search manners in the process of searching for combined beam, where the combined beam may be first searched within a range adjacent to the leading beam, and if the search result is not ideal, the combined beam may be searched and finally determined in a range of the beams that is not adjacent to the leading beam. In addition, the combined beam may be directly searched and determined within the range of the beams that is not adjacent to the leading beam.

There are many cases where the search range of the beams is not adjacent to the leading beam. FIG. 12 respectively shows various cases in which the combined beam search range, such as laterally spaced from the leading beam (FIG. 12(a)), longitudinal spaced from the leading beam (FIG. 12(b)) or diagonally connected to and cross spaced from the leading beam (FIG. 12(c), (d)), is determined in the case of the leading beam have already been determined. The search range of the combined beam described above is only an example, and the mobile station may also determine the range according to the other arrangement manners, in addition, the search range of the combined beam may be horizontally, longitudinally, or obliquely spaced from the leading beam by any number of rows and columns, and is not limited to one row and/or one column. In the embodiments of the present application, the method of determining the combined beam is similar to the method of determining the leading beam described above, i.e., the combined beam may also be selected by the conditions associated with the channel quality, the data throughput, or the transmission power after the combination of the leading beam and the combined beam.

In one embodiment of the present application, the mobile station may determine the beam group and its corresponding reference beam according to the leading beam and the combined beam, where the beam group includes the leading beam and the combined beam, and the reference beam is used to indicate the range of the beam group and is same or different from the leading beam.

In the embodiments of the present application, after the selection of the leading beam and the combined beam, alternatively, the beam group including a preset number (for example, 8) of beams may be determined with the leading beam and the combined beam, and its reference beam may be determined based on this beam group. In the above example, the beam groups shown each include 8 beams, however, in practical applications, the number of beams of the beam group may be any number. Preferably, in order to save feedback overhead, the beam group may include 2ⁿ or 2ⁿ+1 beams. In addition, for different numbers of antenna port, beam group with the same number of beams may be set to make the feedback load same, thereby simplifying system setting. The position of the reference beam in the beam group may be preset and may be located at any position of the beam group. Alternatively, the reference beam may be located as close as possible to the leading beam. The range of the beam group and the relative position of the reference beam in the beam group may be not only specified by the base station to the mobile station, but also fed back to the base station by the mobile station, or learned by the base station and the mobile station based on preset rules. In one embodiment of the application, the reference beam may be different from the leading beam.

Certainly, in another embodiment of the present application, the reference beam may also be undefined, and the mobile station may directly select the leading beam and the combined beam combined with the leading beam according to the steps S1101-S1102 described above.

Alternatively, after the mobile station determines the range of the beam group and the position of the reference beam, the mobile station may feed back information indicating the reference beam to the base station, and indicate the position of the selected leading beam and the combined beam relative to the reference beam to the base station based on the information. In the embodiments of the present application, the mobile station may select any suitable manner as needed to feed back the information of the reference beam, for example, the mobile station may feed back an index of the reference beam, and enable the base station determine the leading beam and the combined beam by feeding back the position of the leading beam and the combined beam relative to the reference beam. When the distance between the leading beam and the combined beam is large, the mobile station may also reflect the position of the leading beam or the combined beam by feeding back the periodic mapping of the leading beam and/or the combined beam in the codebook. The feedback manners of the mobile station may be configured by the base station. For example, the mobile station may feed back the reference beam index periodically or non-periodically. In addition, the mobile station may feed back the reference beam index at a longer time interval and/or for a wide frequency band. The mobile station may feed back the reference beam index at a same timing or frequency as the RI. In a case that the mobile station is configured to carry out an aperiodic feedback, the mobile station may feed back the index of the reference beam with at least one of RI, PMI and CQI; in a case that the mobile station is configured for periodic feedback, a feedback period of the reference beam index may be the same as or different from a feedback period of the RI, PMI and/or CQI.

In addition, when the mobile station does not need to determine the reference beam, the mobile station may directly feed back the information indicating the leading beam and the combined beam to the base station. For example, the mobile station may respectively feed back the leading beam index and the combined beam index to the base station, or may feed back the leading beam index to the base station, and then feed back the information of combined beam through a position of the combined beam relative to the leading beam. The feedback manner of the leading beam index is similar to that of the reference beam index described above, and is not described herein.

Where the difference between the beam selection method in the embodiments of the present application and the current standardization working assumption is: when the leading beam index is represented as: k₁⁽⁰⁾=i_{1,1=}0, 1, . . . N₁O₁−1, k₂(0)=i_{1,2}=0, 1, . . . N₂O₂−1, for a case of diagonally connected and cross spaced from the leading beam, the combined beam index that may be selected may be modified as: k₁⁽¹⁾=i_{1,1}+O₁d₁, k₂⁽¹⁾=i_{1,2}+O₂d₂. Wherein, a range of values of N1 and N2 inferred from the different number of antenna ports may also define d₁=0, . . . , min(N₁,L₁)−1, d₂=0, . . . , min(N₂,L₂)−1, (d₁,d₂)(0,0). The values of L₁ and L₂ are as described above. Wherein,

$${d}_{2} = \{ \begin{matrix}1 , 3 & if {d}_{1} ∈ \{ 1 , 3 \} \\ 0 , 2 & if {d}_{1} = 2 \\ 2 & if {d}_{1} = 0\end{matrix}$$

Wherein, for a case of horizontally spaced one line from the leading beam, the combined beam index is modified as: k₁⁽¹⁾=i_{1,1}+2O₁d₁, k₂⁽¹⁾=i_{1,2}+O₂d₂, where, d₁=0, . . . , min(N₁,L₁)−1, d₂=0, . . . , min(N₂,L₂)−1, (d₁,d₂)≠(0,0). The values of L₁ and L₂ are as described above.

For a case of vertically spaced one line from the leading beam, the combined beam index is modified as: k₁⁽¹⁾=i_{1,1}+O₁d₁, k₂⁽¹⁾=i_{1,2}+2O₂d₂, where d₁=0, . . . , min(N₁,L₁)−1, d₂=0, . . . , min(N₂,L₂)−1, (d₁,d₂)≠(0,0). The values of L₁ and L₂ are as described above.

After receiving the beam index fed back by the mobile station, the base station may acquire a corresponding CSI-RS or CSI process according to the determined leading beam and combined beam, and then determine a precoding vector suitable for data that will be transmitted to the mobile station. The base station may then precode the data transmitted to the mobile station using the precoding vector and transmit the precoded data to the mobile station.

In the beam selection method according to the embodiments of the present application, the beam selection range may be expanded, thereby optimizing a configuration of a channel transmission resource, increasing coverage of a channel transmission, and improving an information transmission quality.

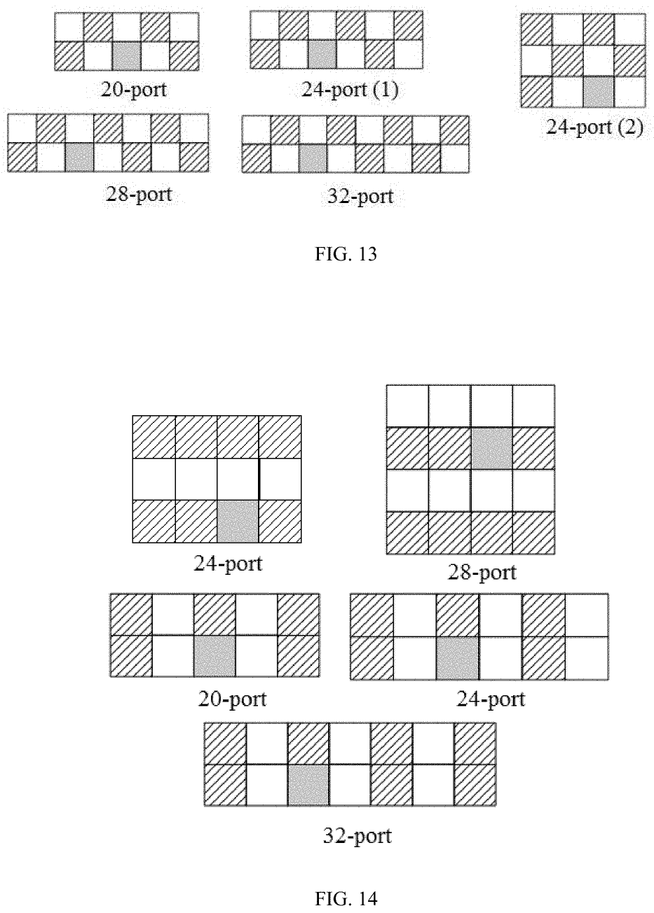

FIG. 13 and FIG. 14 shows an exemplary diagram of a beam selection in the case of a multi-port antenna according to the beam selection method of the embodiments of the present application, where FIG. 13 shows a schematic diagram of the beam selection range where the beams are diagonally connected and cross spaced from the leading beam in a case of respective antenna ports, and FIG. 14 shows a schematic diagram of the beam selection range where the beams are laterally spaced or longitudinally spaced from the leading beam in a case of respective antenna ports. It may be seen that in the above example, the numbers of beams of the beam group are all eight, but in other embodiments of the present application, the number of beams of the beam group is not necessarily limited to eight.

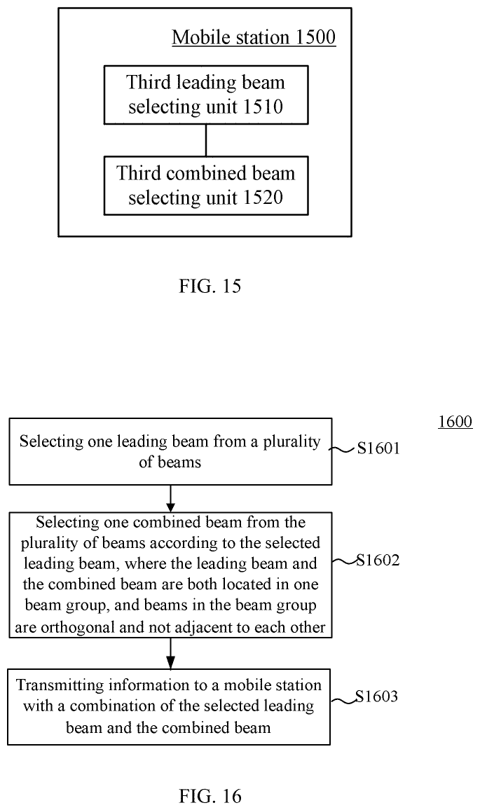

Next, the mobile station according to the third embodiment of the present application will be described with reference to FIG. 15. The UE may perform the beam selection method described above. Since the operation of the UE is substantially the same as the respective steps of the beam selection method described above, only a brief description thereof will be made herein, and a repeated description of the same content will be omitted.

As shown in FIG. 15, a UE 1500 includes a third leading beam selecting unit 1510 and a third combined beam selecting unit 1520. It is to be appreciated that FIG. 15 only shows means related to the embodiments of the present application, while other means are omitted. But this is merely illustrative, and the UE 1500 may include other means as needed.

The third leading beam selecting unit 1510 selects one leading beam from the plurality of beams. As mentioned above, the third leading beam selecting unit 1510 may select one leading beam from the plurality of beams according to conditions associated with the channel quality, the data throughput, or the transmission power of the channel corresponding to respective beams. In particular, the third leading beam selecting unit 1510 may carry out channel estimation for each beam, so as to determine the channel quality of the channel corresponding to each beam, which may be represented by, for example, the channel quality indicator (CQI) or the like.

The third combined beam selecting unit 1520 may select one combined beam from the plurality of beams according to the selected leading beam, where the leading beam and the combined beam are both located in one beam group, and the beams in the beam group are orthogonal and not adjacent to each other. The selection for the combined beam by third combined beam selecting unit 1520 will be neither subject to limitation that adjacent to the leading beam, nor subject to the previous mentioned limitation that the combined beam must be located in the upper right of the leading beam in the limited number (for example, 8) of the beam group, but the orthogonal beam with the best channel quality after combining with the leading beam may be searched around the leading beam and selected as the combined beam. There are many search manners in the process of searching for combined beam, where the combined beam may be first searched within the range adjacent to the leading beam, and if the search result is not ideal, the combined beam may be searched and finally determined in the range of the beams that is not adjacent to the leading beam. In addition, the combined beam may be directly searched and determined within the range of the beams that is not adjacent to the leading beam.

In one embodiment of the present application, the beam group and its corresponding reference beam may also be determined according to the leading beam and the combined beam, where the beam group includes the leading beam and the combined beam, and the reference beam is used to indicate the range of the beam group and is different from the leading beam.

In the embodiments of the present application, after the selection of the leading beam and the combined beam, alternatively, the beam group including the preset number (for example, 8) of beams may be determined with the leading beam and the combined beam, and its reference beam may be determined based on this beam group. In the above example, the beam groups shown each include 8 beams, however, in practical applications, the number of beams of the beam group may be any number. Preferably, in order to save feedback overhead, the beam group may include 2n or 2ⁿ+1 beams. In addition, for different numbers of antenna port, beam group with the same number of beams may be set to make the feedback load same, thereby simplifying system setting. The position of the reference beam in the beam group may be preset and may be located at any position of the beam group. Alternatively, the reference beam may be located as close as possible to the leading beam. The range of the beam group and the relative position of the reference beam in the beam group may be not only specified by the base station to the mobile station, but also fed back to the base station by the mobile station, or learned by the base station and the mobile station based on preset rules. In one embodiment of the application, the reference beam may be different from the leading beam.

Certainly, in another embodiment of the present application, the reference beam may also be undefined, and the leading beam and the combined beam combined with the leading beam may be directly selected.

Alternatively, after the determination of the range of the beam group and the position of the reference beam, the information indicating the reference beam may be fed back to the base station, and the position of the selected leading beam and the combined beam relative to the reference beam may be indicated to the base station based on the information.

In addition, when it is not necessary to determine the reference beam, the information indicating the leading beam and the combined beam may be directly fed back to the base station. For example, the mobile station may respectively feed back the leading beam index and the combined beam index to the base station, or may feed back the leading beam index to the base station, and then feed back the information of combined beam through the position of the combined beam relative to the leading beam. The feedback manner of the leading beam index is similar to that of the reference beam index described above, and is not described herein.

After receiving the beam index fed back by the mobile station, the base station may acquire the corresponding CSI-RS or CSI process according to the determined leading beam and combined beam, and then determine the precoding vector suitable for the data that will be transmitted to the mobile station. The base station may then precode the data transmitted to the mobile station using the precoding vector and transmit the precoded data to the mobile station.

The mobile station according to the embodiments of the present application can expand the beam selection range, thereby optimizing the configuration of the channel transmission resource, increasing the coverage of the channel transmission, and improving the information transmission quality.

### Fourth Embodiment

FIG. 16 shows a flowchart of a beam selection method 1600, which may be performed by a base station, according to the embodiments of the present application. The beam selection method 1600 performed by the base station shown in FIG. 16 is similar to the beam selection method 1100 performed by the mobile station shown in FIG. 11, and same or similar descriptions are not described herein again.

As shown in FIG. 16, in step S1601, the base station selects one leading beam from a plurality of beams. In this step, as mentioned above, the base station may select one leading beam from the plurality of beams according to conditions associated with channel quality, data throughput, or transmission power of a channel corresponding to respective beams fed back by the mobile station. In particular, the base station may acquire a channel estimation carried out by the mobile station for each beam, so as to determining the channel quality of the channel corresponding to each beam, which may be represented by, for example, a channel quality indicator (CQI) or the like.

In step S1602, one combined beam is selected from the plurality of beams according to the selected leading beam, where the leading beam and the combined beam are both located in one beam group, and beams in the beam group are orthogonal and not adjacent to each other. In this step, the selection for the combined beam will be neither subject to limitation that adjacent to the leading beam, nor subject to the previous mentioned limitation that the combined beam must be located in the upper right of the leading beam in a limited number (for example, 8) of the beam group, but a orthogonal beam with the best channel quality after combining with the leading beam may be searched around the leading beam and selected as the combined beam. There are many search manners in the process of searching for combined beam, where the combined beam may be first searched within a range adjacent to the leading beam, and if the search result is not ideal, the combined beam may be searched and finally determined in a range of the beams that is not adjacent to the leading beam. In addition, the combined beam may be directly searched and determined within the range of the beams that is not adjacent to the leading beam.

In step S1603, the base station may transmit information to the mobile station with a combination of the selected leading beam and the combined beam, where the base station may acquire a corresponding CSI-RS or CSI process according to the determined leading beam and combined beam, and then determine a precoding vector suitable for data transmitted to the mobile station. The base station may then precode the data that will be transmitted to the mobile station using the precoding vector and transmit the precoded data to the mobile station.

In the beam selection method according to the embodiments of the present application, the beam selection range may be expanded, thereby optimizing a configuration of a channel transmission resource, increasing coverage of a channel transmission, and improving an information transmission quality.

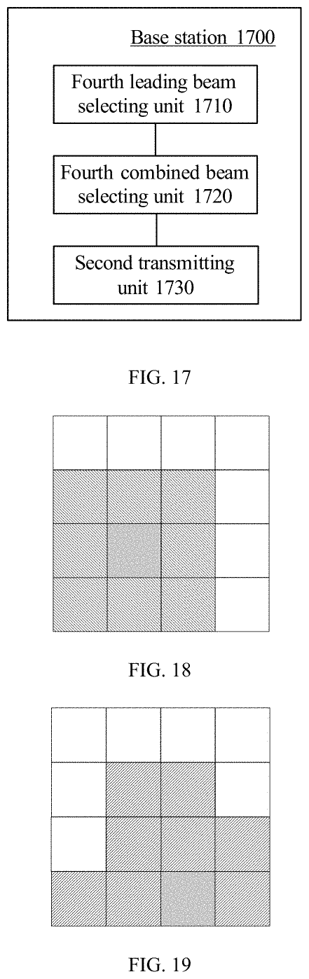

Next, the base station according to the fourth embodiment of the present application will be described with reference to FIG. 17. The base station may perform the beam selection method described above. Since the operation of the base station is substantially the same as the respective steps of the beam selection method described above, only a brief description thereof will be made herein, and a repeated description of the same content will be omitted.

As shown in FIG. 17, a base station 1700 includes a fourth leading beam selecting unit 1710, a fourth combined beam selecting unit 1720, and a second transmitting unit 1730. It is to be appreciated that FIG. 17 only shows means related to embodiments of the present application, while other means are omitted. But this is merely illustrative, and base station 1700 may include other means as needed.

The fourth leading beam selecting unit 1710 selects one leading beam from the plurality of beams. As mentioned above, the fourth leading beam selecting unit 1710 may select one leading beam from the plurality of beams according to conditions associated with the channel quality, the data throughput, or the transmission power of the channel corresponding to respective beams fed back by the mobile station. In particular, the base station may acquire the channel estimation carried out by the mobile station for each beam, so as to determine the channel quality of the channel corresponding to each beam, which may be represented by, for example, the channel quality indicator (CQI) or the like.

The fourth combined beam selecting unit 1720 may select one combined beam from the plurality of beams according to the selected leading beam, where the leading beam and the combined beam are both located in one beam group, and beam in the beam group are orthogonal and not adjacent to each other. The selection for the combined beam will be neither subject to limitation that adjacent to the leading beam, nor subject to the previous mentioned limitation that the combined beam must be located in the upper right of the leading beam in the limited number (for example, 8) of the beam group, but the orthogonal beam with the best channel quality after combining with the leading beam may be searched around the leading beam and selected as the combined beam. There are many search manners in the process of searching for combined beam, where the combined beam may be first searched within the range adjacent to the leading beam, and if the search result is not ideal, the combined beam may be searched and finally determined in a range of the beams that is not adjacent to the leading beam. In addition, the combined beam may be directly searched and determined within the range of the beams that is not adjacent to the leading beam.

The second transmitting unit 1730 may transmit information to the mobile station with the combination of the selected leading beam and the combined beam, where the base station may acquire the corresponding CSI-RS or CSI process according to the determined leading beam and combined beam, and then determine the precoding vector suitable for data transmitted to the mobile station. The base station may then precode the data that will be transmitted to the mobile station using the precoding vector and transmit the precoded data to the mobile station.

The base station according to the embodiments of the present application can expand the beam selection range, thereby optimizing the configuration of the channel transmission resource, increasing the coverage of the channel transmission, and improving the information transmission quality.

In addition, as mentioned above, the number of beams included in the beam group may vary according to requirements of the practical applications, where the beam group is selected in beam selection method, the mobile station and the base station in the embodiments of the present application. FIG. 18 and FIG. 19 shows schematic diagrams of the beam group selection range in the embodiments of the present application, respectively. As shown in FIG. 18, the range of beam group selected in the embodiments of the present application may include the leading beam and all adjacent orthogonal beams around the leading beam, and the number of beams in the beam group may be, for example, nine. As shown in FIG. 19, the selected beam group in the embodiments of the present application also includes nine beams, but may include the leading beam and some orthogonal beams adjacent thereto or not adjacent thereto. The combined beam may be selected according to a statistical result in the embodiment of the present application as shown in FIG. 19. The statistical result herein refers to: counting the position of the selected combined beam relative to the leading beam after the determination the leading beam, and forming into one beam group using the combined beam with high frequency of occurrence, where the one beam group is the default between the base station and the user equipment. The beam group may be determined by indicating the information of the leading beam when the mobile station feedbacks, and then the combined beam is selected from the beam group. Certainly, the beam group in the embodiments of the present application may also include other numbers of beams in practical applications.

The base station in the embodiments of the present application can accommodate one or more (for example, three) (also referred to as segments) cells. In the case where the base station accommodates a plurality of cells, the coverage area of the base station may be entirely divided into a plurality of smaller areas, each of which may utilize a base station subsystem (for example, a small base station for indoor use: remote radio head (RRH)) to provide communication service. The terms “cell” or “segment” refer to a portion or the entirety of the coverage area of the base station and/or the base station subsystem that carries out communication services in the coverage area. Moreover, the terms “base station”, “eNB”, “cell” and “segment” can be used interchangeably in the present specification. The base station is sometimes also referred to as a fixed station, a NodeB, an eNodeB (eNB), an access point, a femto cell, a small cell or the like.

Mobile stations in the embodiments of the present application vary from those skilled in the art and are sometimes referred to as user stations, mobile units, user units, wireless units, remote units, mobile devices, wireless devices, wireless communication devices, remote devices, mobile user stations, access terminals, mobile terminals, wireless terminals, remote terminals, handheld devices, user agents, mobile clients, clients, or other suitable terms.

It should be noted that a block diagram used in the description of the above described embodiments represents a functional block of a functional unit. These functional blocks (composition units) are implemented by any combination of hardware and/or software. In addition, the implementation means of each function block are not particularly limited. That is, each functional block may be implemented by one apparatus that is physically and/or logically combined, or two or more apparatus that are physically and/or logically separated may be directly and/or indirectly (for example, wired and/or wireless) connected, and each functional block may be implemented by the multiple apparatus.

For example, base stations, mobile stations or the like in one embodiment of the present application may function as a computer that carries out processing of the beam selection method of the present application. The base stations and the mobile stations may be physically configured as a computer apparatus including processor, storage, memory, communication apparatus, input apparatus, output apparatus and bus or the like.

It should be noted that in the following description, the term “apparatus” can be interpreted as a circuit, a device, a unit or the like. The functions related to the base station and the mobile station are implemented by reading the specified software (program) on the hardware such as the processor and the storage, with the processor carrying out calculations, and by controlling the communication carried out by the communication apparatus 1004 and the reading and/or writing of data in the storage and the memory.

The processor operates, for example, on an operating system to control the entire computer. The processor may be composed of a central processing unit (CPU) including interfaces with peripheral apparatus, control apparatus, arithmetic apparatus, registers, or the like.

In addition, the processor reads the program (program code), software modules, and data from the memory and/or the communication apparatus into the storage, and performs various processes according to the contents thereof. As the program, use the program that causes the computer to perform at least a portion of the actions described in the above described embodiments. For example, the control unit of the mobile station is stored in the storage, and can be implemented by the control program that executes in the processor, and the other functional blocks may be similarly implemented. The above described various processes are described with the subject matter of performing in one processor, but may also be performed simultaneously or sequentially by two or more processors. The processor may be implemented by more than one chip. It should be noted that the program can be transmitted from the network via a communication circuit.

The storage is a recording medium readable by the computer, and for example may be composed of at least one of a ROM (read only memory), an EPROM (erasable programmable ROM), an EEPROM (electrically erasable programmable ROM), and a RAM (random access memory). The storage may be referred to as a register, a cache memory, a main storage (primary storage apparatus), or the like. The storage can store an executable program (program code), software modules, or the like, for implementing the wireless communication method of one embodiment of the present application.

The memory is a computer-readable recording medium, and for example may be composed of by at least one of a CD-ROM (compact disc ROM), a hard disk driver, a floppy magnetic disk, a magneto-optical disk (for example, a compact disk, a digital versatile disk, a Blu-ray (registered trademark) disk), a smart card, a flash memory (such as a flash memory card, a flash memory stick, a thin flash memory), a floppy disk (floppy disk registered trademark), and a magnetic stripe, or the like. The memory may be referred to as a secondary storage apparatus. The above described storage medium may be, for example, other suitable media such as databases, servers, or the like, including storage and/or memory.

The communication apparatus 1004 is hardware (transceiver device) that carries out communication between the computers via a wired and/or wireless network, and is also referred to as, for example, a network apparatus, a network controller, a network card, a communication module, or the like. For example, the above described transceiver antenna, the amplifying unit, the transceiver unit, and the transmission path interface, or the like, may be implemented by the communication apparatus.

The input apparatus is an input device (for example, a keyboard, a mouse, a microphone, a switch, a button, a sensor, or the like.) that takes input from the outside. The output apparatus is an output device (for example, a display, a speaker, an LED lamp, or the like) that performs an output to the outside. It should be noted that the input apparatus and the output apparatus may have an integrated structure (for example, a touch screen).

In addition, the various apparatus such as the processor and the storage are connected by the bus via which the information is communicated. The bus may be composed of a single bus or different buses between apparatus.

In addition, the radio base station and the mobile station may include hardware such as a microprocessor, a digital signal processor (DSP), an ASIC (application specific integrated circuit), a PLD (programmable logic device), an FPGA (field programmable gate array), or the like as compositions, and some or all of the functional blocks may be implemented by the hardware. For example, the processor may be implemented by at least one of the hardware.

The respective manners/implementations described in the present specification may be applied to LTE (long term evolution), LTE-A (LTE-Advanced), SUPER 3G, IMT-Advanced, 4G, 5G, FRA (future radio access), W-CDMA (registered trademark), GSM (registered trademark), CDMA2000, UMB (ultra-mobile broadband), IEEE 802.11 (Wi-Fi), IEEE 802.16 (WiMAX), IEEE 802.20, UWB (ultra-wideband), Bluetooth (registered trademarks), systems that utilize other suitable systems, and/or next-generation systems that are extended based on these.

Software is independent of being referred to as software, firmware, middleware, microcode, hardware description language, or being referred to as other names, and may be broadly interpreted as instructions, instruction sets, code, code segments, program code, programs, subroutines, software modules, applications, software applications, software packages, routines, subroutines, objects, executable files, threads of execution, steps, functions, or the like.

In addition, software, instructions, or the like may transceiver signals via a transmission medium. For example, in the case where the software transmits from web pages, servers, or other remote data sources using wired technologies such as a coaxial cable, a fiber, a twisted pair, and a digital subscriber line (DSL) and/or wireless technologies such as infrared, wireless and microwave, these wired technologies and/or wireless technologies are included in the definition of the transmission medium.

The terms “consist”, “including”, and variations thereof as used in the specification or the claims are used to represent “comprising” as same as term “having”. Moreover, the term “or” as used in the specification or claims is intended to represent that it is not exclusive.

Therefore, the present application is explained in detail by using the above-described embodiments; however, it should be understood by those skilled in the art that the present application is not limited to the embodiments explained herein. The application may be implemented as a corrected, modified mode without departing from the scope of the application as defined by the appended claims. Therefore, the description of the specification is only intended to explain the examples, and does not impose any limitation on the application.

1-10. (canceled)

11. A mobile station, comprising:
a first leading beam selecting unit configured to select one leading beam from a plurality of beams;
a first combined beam selecting unit configured to select one combined beam from the plurality of beams according to the selected leading beam, where the leading beam and the combined beam are both located in one beam group, and beams in the beam group are orthogonal and adjacent to each other;
a first reference beam determining unit configured to determine a corresponding reference beam according to the beam group, wherein the reference beam is used to indicate a range of the beam group and is different from the leading beam.

12. A mobile station, comprising:
a third leading beam selecting unit configured to select one leading beam from a plurality of beams;
a third combined beam selecting unit configured to select one combined beam from the plurality of beams according to the selected leading beam, where the leading beam and the combined beam are both located in one beam group, and beams in the beam group are orthogonal and not adjacent to each other.

13. The mobile station of claim 11, wherein
the first leading beam selecting unit selects one leading beam according to a channel state corresponding to the plurality of beams.

14. The mobile station of claim 11, wherein
the first leading beam selecting unit selects the combined beam according to a channel state corresponding to a combination of the leading beam and selected combined beam.

15. The mobile station of claim 11, wherein
the first reference beam determining unit feeds back, to a base station, information indicating the reference beam, and indicates, to the base station, positions of the selected leading beam and the combined beam relative to the reference beam based on the information.

16. The mobile station of claim 12, wherein
the third combined beam selecting unit determines a corresponding reference beam according to the beam group, wherein the reference beam is used to indicate a range of the beam group.

17. The mobile station of claim 12, wherein
the beams in the beam group are laterally spaced, longitudinally spaced or diagonally connected.

18. The mobile station of claim 12, wherein
the third combined beam selecting unit indicates, to the base station, information of the selected leading beam and the combined beam.

19. A base station, comprising:
a second leading beam selecting unit configured to select one leading beam from a plurality of beams;
a second combined beam selecting unit configured to select one combined beam from the plurality of beams according to the selected leading beam, where the leading beam and the combined beam are both located in one beam group, and beams in the beam group are orthogonal and adjacent to each other;
a second reference beam determining unit configured to determine a corresponding reference beam according to the beam group, wherein the reference beam is used to indicate a range of the beam group and is different from the leading beam;
a first transmitting unit configured to transmit information to a mobile station with a combination of the selected leading beam and the combined beam.

20. The base station of claim 19, wherein
the second leading beam selecting unit selects one leading beam according to a channel state corresponding to the plurality of beams.

21. The base station of claim 19, wherein
the second leading beam selecting unit selects the combined beam according to a channel state corresponding to a combination of the leading beam and selected combined beam.
